(19) United States
(12) Patent Application Publication
(10) Pub. No.: US 2024/0137856 A1
(43) Pub. Date: Apr. 25, 2024

(54) COMMUNICATION SYSTEMS, METHODS, AND NON-TRANSITORY COMPUTER-READABLE STORAGE DEVICES USING JOINT INITIAL ACCESS WITH TERRESTRIAL AND NON-TERRESTRIAL COMMUNICATION NODES

(71) Applicant: HUAWEI TECHNOLOGIES CO., LTD., Shenzhen (CN)

(72) Inventors: AMAN JASSAL, Ottawa (CA); Amine Maaref, Ottawa (CA); Jianglei Ma, Ottawa (CA)

(21) Appl. No.: 18/401,906

(22) Filed: Jan. 2, 2024

Related U.S. Application Data
(63) Continuation of application No. PCT/CN2021/104226, filed on Jul. 2, 2021.

(51) Int. Cl. H04W 48/20; H04W 56/00; H04W 76/10; H04W 84/06

(52) U.S. Cl. CPC H04W 48/20; H04W 56/0015; H04W 76/10; H04W 84/06

(57) ABSTRACT

A communication system, a method, and one or more non-transitory computer-readable storage devices allowing joint a user equipment to perform initial access with terrestrial and non-terrestrial communication nodes of a service area. The service area is partitioned into terrestrial initial-access zones and non-terrestrial initial-access zones with each terrestrial initial-access zone associated with one or more of the terrestrial communication nodes and each non-terrestrial initial-access zone associated with at least one of the non-terrestrial communication nodes. The user equipment uses positioning reference signals from positioning anchors to determine its location, determine a zone from the terrestrial and non-terrestrial initial-access zones based on the location, select one of the terrestrial and non-terrestrial communication nodes based on the determined zone, and establishing communication with the selected communication node.

### CROSS-REFERENCE TO RELATED APPLICATIONS

This application is a continuation application of Patent Cooperation Treaty International Application Ser. No. PCT/CN2021/104226, filed on Jul. 2, 2021, the content of which is hereby incorporated by reference in its entirety.

### FIELD OF THE DISCLOSURE

The present disclosure relates generally to communication systems and methods, and in particular to communication systems and methods using joint initial access with terrestrial and non-terrestrial communication nodes.

### BACKGROUND

For ease of reading, subsection C of the Detailed Description lists the acronyms used in this disclosure.

Mobile communication systems are known. While most mobile communication systems are so-called terrestrial network systems (which generally comprise a plurality of terrestrial transmit-receive points (TRPs) deployed on the ground), non-terrestrial network systems (which generally comprise a plurality of non-terrestrial TRPs deployed above ground or in the space) are also deployed or started their deployment in recent years. However, in prior-art mobile communication systems, the initial access procedures are defined separately in terrestrial and non-terrestrial network systems. Consequently, a user equipment (UE) such as a smartphone has to monitor for basic system information on both terrestrial and non-terrestrial networks, and thus has to maintain separate functions and state machines for communication links with terrestrial and non-terrestrial TRPs, which may cause extra computational load, extra power consumption, and/or slowed computational speed at the UE side.

Another issue of prior-art mobile communication systems is related to the integration of initial access with legacy procedures. For example, cell selection (that is, a UE selecting the best suitable cell to acquire system information (SI)) inherently excludes non-terrestrial nodes, and cell search (a UE scanning all radio frequency (RF) channels it has support for in order to find the best suitable cell) does not distinguish between terrestrial or non-terrestrial TRPs. Such an issue makes seamless integration of terrestrial and non-terrestrial TRP initial access at the UE side inherently difficult. Moreover, initial access in current 5G NR systems relies on beam-sweeping in order for the UE to find the best cell based on its respective synchronization signal physical broadcast channel (SS/PBCH) blocks. Therefore, when a UE starts the initial access to join a mobile communication system (or when the UE wakes up after a long time and has to find an appropriate beam again), the UE may need to try several beam assumptions before finally settling on the best beam assumption. Such an issue may cause extra computational load, extra power consumption, and/or slowed computational speed. Since 5G NR Release 16, UEs are able to determine their locations based on positioning reference signals; this procedure is known as “positioning”. However, such positioning functions are currently limited to when the UE is in CONNECTED state and are typically initiated at the network side by the communication network or the access and mobility function (AMF).

Therefore, there is a desire for a communication system with improved initial access functions integrating both terrestrial and non-terrestrial TRPs.

### SUMMARY

Embodiments of this disclosure relate to systems and methods with joint initial access with terrestrial and non-terrestrial transmit-receive points (TRPs) (also called “communication nodes” hereinafter). The systems and methods disclosed herein provide solutions for solving at least some of the above-described issues associated with initial access. The systems and methods disclosed herein thus may be used with existing mobile communication technologies such as 4G and 5G mobile communication technologies, and/or may be used with future mobile communication technologies such as 6G mobile communication technologies.

According to one aspect of this disclosure, there is provided a communication system, a method, and one or more non-transitory computer-readable storage devices allowing joint a user equipment to perform initial access with terrestrial and non-terrestrial communication nodes of a service area. The service area is partitioned into terrestrial initial-access zones and non-terrestrial initial-access zones with each terrestrial initial-access zone associated with one or more of the terrestrial communication nodes and each non-terrestrial initial-access zone associated with at least one of the non-terrestrial communication nodes. The user equipment uses positioning reference signals from positioning anchors to determine its location, determine a zone from the terrestrial and non-terrestrial initial-access zones based on the location, select one of the terrestrial and non-terrestrial communication nodes based on the determined zone, and establish communication with the selected communication node.

According to one aspect of this disclosure, the communication system disclosed herein (i) enables the user equipment to receive positioning reference signals and use the received positioning reference signals to determine its location, (ii) defines terrestrial and non-terrestrial initial-access zones and provides the coverage information of the terrestrial and non-terrestrial initial-access zones and the coverage information of the corresponding terrestrial and non-terrestrial TRPs to the user equipment to help the user equipment determine which one of the terrestrial initial-access sub-process and the non-terrestrial initial-access sub-process to be used for completing the initial access process; and (iii) enables the user equipment to perform the simplified initial access using system information (SI) acquired from non-terrestrial TRPs, without cell search or cell selection, and with reduced beam-sweeping time.

According to one aspect of this disclosure, there is provided an apparatus which comprises a memory, a transceiver, and a processing unit functionally coupled to the memory and the transceiver for executing a joint initial access procedure for joining the user equipment into a communication system. The joint initial access procedure comprises: selecting one of a terrestrial initial-access procedure and a non-terrestrial initial-access procedure based on a position of the user equipment; and executing the selected initial access procedure for joining the user equipment into the communication system.

Optionally, in any of the previous embodiments, said selecting the one of the terrestrial initial-access procedure and the non-terrestrial initial-access procedure based on the position of the user equipment comprises: receiving coverage information of a service area; and selecting the one of the terrestrial initial-access procedure and the non-terrestrial initial-access procedure based on the coverage information and the position of the user equipment.

Optionally, in any of the previous embodiments, said selecting the one of the terrestrial initial-access procedure and the non-terrestrial initial-access procedure based on the coverage information and the position of the user equipment comprises: identifying one or more terrestrial initial-access zones and one or more non-terrestrial initial-access zones using the received coverage information; receiving positioning reference signals from a plurality of positioning anchors; determining a location of the user equipment based on the received positioning reference signals; determining, from the one or more terrestrial initial-access zones and the one or more non-terrestrial initial-access zones, a zone thereof that the user equipment is located therewithin based on the determined location thereof and the coverage information; and selecting the one of the terrestrial initial-access procedure and the non-terrestrial initial-access procedure based on the determined zone.

Optionally, in any of the previous embodiments, the terrestrial initial-access procedure comprises: selecting a communication node from one or more identified terrestrial communication nodes associated with the determined zone; and establishing communication between the user equipment and the selected communication node for joining the user equipment into the communication system.

Optionally, in any of the previous embodiments, said selecting the communication node from the one or more identified terrestrial communication nodes associated with the determined zone comprises: scanning radio-frequency (RF) channels associated with the one or more identified terrestrial communication nodes for identifying the one or more identified terrestrial communication nodes; selecting the communication node from the identified one or more identified terrestrial communication nodes; and performing time and frequency synchronization between the user equipment and the selected communication node.

Optionally, in any of the previous embodiments, the non-terrestrial initial-access procedure comprises: selecting a communication node from one or more identified non-terrestrial communication nodes associated with the determined zone; and establishing communication between the user equipment and the selected communication node for joining the user equipment into the communication system.

Optionally, in any of the previous embodiments, said selecting the communication node from the one or more identified non-terrestrial communication nodes associated with the determined zone comprises: scanning RF channels associated with the one or more identified non-terrestrial communication nodes for identifying the one or more identified non-terrestrial communication nodes; selecting the communication node from the identified one or more identified non-terrestrial communication nodes; and performing time and frequency synchronization between the user equipment and the selected communication node.

Optionally, in any of the previous embodiments, the one or more identified non-terrestrial communication nodes comprise one or more satellites, one or more drones, one or more balloons, one or more airships, one or more aircrafts, and/or a combination thereof.

Optionally, in any of the previous embodiments, the positioning anchors comprise at least one of the one or more identified non-terrestrial communication nodes.

Optionally, in any of the previous embodiments, the user equipment further comprises: a static storage device functionally coupled to the processing unit; and said receiving the coverage information of the service area comprises receiving the coverage information of the service area via the static storage device.

Optionally, in any of the previous embodiments, the static storage device comprises a SIM card, an eSIM card, and/or a wireless internet stick.

Optionally, in any of the previous embodiments, the coverage information comprises one or more of non-terrestrial frequency band information of one or more of the plurality of positioning anchors, beamforming information of the one or more positioning anchors, and predefined coordinates of the one or more positioning anchors with respect to a first reference coordinate system, for detecting the positioning reference signals of the one or more positioning anchors.

Optionally, in any of the previous embodiments, each of the positioning reference signals is defined using a pseudo-random sequence with an initial-sequence parameter value for initializing the pseudo-random sequence selected from a group of numbers being used by the one or more positioning anchors for transmitting positioning reference signals using a same frequency band.

Optionally, in any of the previous embodiments, the pseudo-random sequence is a Gold sequence.

Optionally, in any of the previous embodiments, the coverage information comprises the initial-sequence parameter values.

Optionally, in any of the previous embodiments, the beamforming information of the one or more positioning anchors comprises azimuth and zenith angles of beams of the positioning reference signals of the one or more positioning anchors with respect to a second reference coordinate system.

Optionally, in any of the previous embodiments, the first and second reference coordinate systems are a same reference coordinate system.

Optionally, in any of the previous embodiments, said receiving the positioning reference signals from the plurality of positioning anchors comprises: storing radio resource control (RRC) signaling in the memory for retrieving at least one of the non-terrestrial frequency band information, the beamforming information of the one or more positioning anchors, and reference signal information for receiving the positioning reference signals transmitted from the one or more positioning anchors.

Optionally, in any of the previous embodiments, the reference signal information comprises one or more of a cell-specific identifier, a group-specific identifier, a user-specific identifier.

Optionally, in any of the previous embodiments, said receiving the positioning reference signals from the plurality of positioning anchors comprises: scanning for non-terrestrial RF channels of the plurality of positioning anchors on one or more predefined non-terrestrial frequency bands.

Optionally, in any of the previous embodiments, said receiving the positioning reference signals from the plurality of positioning anchors comprises: receiving the positioning reference signals from the plurality of positioning anchors using a multiple-access technology.

Optionally, in any of the previous embodiments, the multiple-access technology comprises at least one of a frequency-division multiple-access technology and a code-division multiple-access technology.

Optionally, in any of the previous embodiments, the processing unit is configured for: storing the coverage information in the memory.

Optionally, in any of the previous embodiments, the processing unit is configured for: when the user equipment wakes up from an IDLE state, retrieving the stored coverage information from the memory.

Optionally, in any of the previous embodiments, the processing unit is configured for: receiving system information from one of the one or more identified non-terrestrial communication nodes.

Optionally, in any of the previous embodiments, the received system information comprises updated coverage information; and the processing unit is configured for: identifying one or more additional non-terrestrial initial-access zones using the updated coverage information; determining that the user equipment is within one of the one or more additional non-terrestrial initial-access zones based on the determined location of the user equipment and the updated coverage information; and selecting an additional non-terrestrial initial-access procedure for establishing communication between the user equipment and an additional communication node associated with the determined additional non-terrestrial zone for joining the user equipment into the communication system.

Optionally, in any of the previous embodiments, the processing unit is configured for: receiving information of at least one of the one or more identified terrestrial communication nodes designated as at least one target terrestrial communication node.

Optionally, in any of the previous embodiments, the processing unit is configured for: storing the information of the at least one target terrestrial communication node.

Optionally, in any of the previous embodiments, the at least one target terrestrial communication node comprises one of the one or more identified terrestrial communication nodes in communication with the user equipment, having signals received by the user equipment exceeding a predefined threshold, having highest reference signal received power (RSRP), having highest reference signal received quality (RSRQ), or having highest signal-to-interference-plus-noise ratio (SINR).

Optionally, in any of the previous embodiments, the information of the at least one target terrestrial communication node comprises Physical Cell Identity (PCI) and beamforming information of the at least one target terrestrial communication node.

Optionally, in any of the previous embodiments, the processing unit is configured for: using the information of the at least one target terrestrial communication node for establishing communication between the user equipment and one of the at least one target terrestrial communication node.

Optionally, in any of the previous embodiments, the processing unit is configured for: signaling the communication system that the user equipment is capable of selecting and executing one of the terrestrial initial-access procedure and the non-terrestrial initial-access procedure.

Optionally, in any of the previous embodiments, the processing unit is configured for: signaling the communication system that the user equipment is capable of storing a maximum of N1 of the non-terrestrial initial-access zones in the memory, where N1 is an integer and N1>0.

Optionally, in any of the previous embodiments, the processing unit is configured for: signaling the communication system that the user equipment is capable of storing beamforming information of a maximum of N2 usable terrestrial communication nodes in the memory, where N2 is an integer and N2>0.

According to one aspect of this disclosure, there is provided a method for a user equipment to join into a communication system. The method comprises: selecting one of a terrestrial initial-access procedure and a non-terrestrial initial-access procedure based on a position of the user equipment; and executing the selected initial access procedure for joining the user equipment into the communication system.

Optionally, in any of the previous embodiments, said selecting the one of the terrestrial initial-access procedure and the non-terrestrial initial-access procedure based on the position of the user equipment comprises: receiving coverage information of a service area; identifying one or more terrestrial initial-access zones and one or more non-terrestrial initial-access zones using the received coverage information; receiving positioning reference signals from a plurality of positioning anchors; determining a location of the user equipment based on the received positioning reference signals; determining, from the one or more terrestrial initial-access zones and the one or more non-terrestrial initial-access zones, a zone thereof that the user equipment is located therewithin based on the determined location thereof and the coverage information, and selecting the one of the terrestrial initial-access procedure and the non-terrestrial initial-access procedure based on the determined zone.

According to one aspect of this disclosure, there is provided one or more non-transitory computer-readable storage devices comprising computer-executable instructions for joining a user equipment into a communication system. The instructions, when executed, cause a processing unit of the user equipment to perform actions comprising: selecting one of a terrestrial initial-access procedure and a non-terrestrial initial-access procedure based on a position of the user equipment; and executing the selected initial access procedure for joining the user equipment into the communication system.

Optionally, in any of the previous embodiments, said selecting the one of the terrestrial initial-access procedure and the non-terrestrial initial-access procedure based on the position of the user equipment comprises: receiving coverage information of a service area; identifying one or more terrestrial initial-access zones and one or more non-terrestrial initial-access zones using the received coverage information; receiving positioning reference signals from a plurality of positioning anchors; determining a location of the user equipment based on the received positioning reference signals; determining, from the one or more terrestrial initial-access zones and the one or more non-terrestrial initial-access zones, a zone thereof that the user equipment is located therewithin based on the determined location thereof and the coverage information, and selecting the one of the terrestrial initial-access procedure and the non-terrestrial initial-access procedure based on the determined zone.

According to one aspect of this disclosure, there is provided one or more controlling devices for joining a user equipment into a communication system. The one or more controlling devices comprises: at least one memory; at least one network interface for communicating with one or more terrestrial communication nodes and one or more non-terrestrial communication nodes for providing communication service to a service area; and at least one processing unit functionally coupled to the memory and the network interface for: maintaining a partition of the service area, said partition dividing the service area into one or more terrestrial initial-access zones and one or more non-terrestrial initial-access zones, each terrestrial initial-access zone associated with at least one terrestrial communication node of the one or more terrestrial communication nodes, and each non-terrestrial initial-access zone being associated with at least one non-terrestrial communication node of the one or more non-terrestrial communication nodes; and providing to the user equipment coverage information of the one or more terrestrial initial-access zones and the one or more non-terrestrial initial-access zones to allow the user equipment to, based on a position thereof, establish communication with the at least one terrestrial communication node associated with one of the one or more terrestrial initial-access zones using a terrestrial initial-access procedure, or with the at least one non-terrestrial communication node associated with one of the one or more non-terrestrial initial-access zones using a non-terrestrial initial-access procedure.

Optionally, in any of the previous embodiments, the at least one processing unit is further configured for broadcasting the coverage information via one of the one or more non-terrestrial communication nodes.

Optionally, in any of the previous embodiments, the at least one processing unit is further configured for: adding to the partition of the service area one or more additional non-terrestrial initial-access zones, each additional non-terrestrial initial-access zone associated with one or more additional non-terrestrial communication nodes; and updating the coverage information to include the one or more additional non-terrestrial initial-access zones.

Thus the technical benefits of the communication system, user equipment, controlling devices, method, and one or more non-transitory computer-readable storage devices disclosed herein in various embodiments may include, but are not limited to:
efficient initial access through selection (by the user equipment) of a suitable initial-access sub-process (that is, a terrestrial initial-access sub-process or a non-terrestrial initial-access sub-process) using the coverage information provided by the communication system via SIM cards;
reliable SI acquisition by leveraging non-terrestrial TRPs which generally have much larger coverage (compared to that of terrestrial TRPs) and are more suitable for broadcast channel reception such as paging/SI reception;
additional flexibility and efficiency achieved by leveraging additional non-terrestrial TRPs using the coverage information provided by the communication system via updated SI;
additional flexibility and efficiency achieved by storing updated coverage information in user equipments;
simplified initial access, wherein with assistance of non-terrestrial TRPs, the user equipment may perform the simplified terrestrial initial-access sub-process using the information of target terrestrial TRPs.

### BRIEF DESCRIPTION OF THE DRAWINGS

FIG. 1 is a simplified schematic diagram showing the structure of a communication system, according to some embodiments of this disclosure;

FIG. 2 is a simplified schematic diagram of a controlling device of a communication network of the communication system shown in FIG. 1;

FIG. 3 is a simplified schematic diagram of a transmit-receive point (TRP) of the communication system shown in FIG. 1;

FIG. 4 is a simplified schematic diagram of a user equipment (UE) of the communication system shown in FIG. 1;

FIG. 5 shows a service area of the communication system shown in FIG. 1, wherein the service area is partitioned into terrestrial and non-terrestrial initial-access zones;

FIG. 6 is a flowchart showing a joint initial access procedure performed by the communication system shown in FIG. 1;

FIG. 7A is a flowchart of the joint initial access procedure shown in FIG. 6, according to some embodiments of this disclosure;

FIG. 7B is a flowchart of the joint initial access procedure shown in FIG. 6, according to some other embodiments of this disclosure;

FIG. 8 shows a service area of the communication system shown in FIG. 1, according to some embodiments of this disclosure, wherein the service area is partitioned into terrestrial, non-terrestrial initial-access zones, and temporarily deployed, additional non-terrestrial initial-access zones;

FIG. 9 is a flowchart of the joint initial access procedure shown in FIG. 6, according to some embodiments of this disclosure;

FIG. 10 shows a service area of the communication system shown in FIG. 1, according to some embodiments of this disclosure;

FIG. 11 is a flowchart of the joint initial access procedure shown in FIG. 6, according to some embodiments of this disclosure; and

FIG. 12 shows a service area of the communication system shown in FIG. 1, according to some embodiments of this disclosure.

### DETAILED DESCRIPTION

### A. System Structure

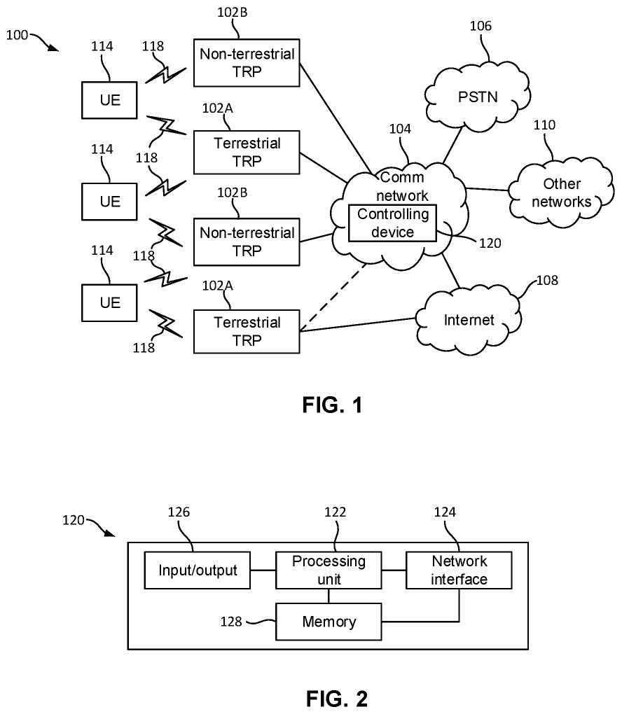

Turning now to FIG. 1, a communication system is shown and is generally identified using reference numeral 100. As shown, the communication system 100 comprises a plurality of transmit-receive points (TRPs) 102 (also denoted “communication nodes” hereinafter), including a plurality of terrestrial TRPs 102A and a plurality of non-terrestrial TRPs 102B, in communication with one or more public switched telephone networks (PSTNs) 106, the Internet 108, and other networks 110 via a communication network 104. Some TRPs 102 access the communication network 104 via the Internet 108. A plurality of user equipments (UEs) 114 are in wireless communication with the TRPs 102 for accessing the communication network 104, the PSTNs 106, the Internet 108, and other networks 110 to make phone calls (to, for example, other UEs 114, landline phones (not shown), and/or the like), exchanging data (for example, sending/receiving emails, sending/receiving instant messages, and/or the like), accessing contents (such as text content, audio content, and/or video content), and/or the like. Examples of UEs 114 may be smartphones, personal digital assistants (PDAs), laptops, computers, tablets, vehicles, sensors, and/or the like.

As those skilled in the art will appreciate, the communication system 100 may operate by sharing resources such as bandwidth, and allow data transmission (for example, transmission of voice, data, video, text, and/or the like) via broadcast (one device to all devices in the system 100; that is, one-to-all), multicast (one device to a plurality of device; that is, one-to-many), unicast (one device to another device such as one UE to another UE; that is, one-to-one), and/or the like.

The PSTN 106 may include circuit switched telephone networks for providing plain old telephone service (POTS). The Internet 108 may include a network of computers and subnets (intranets) or both, and incorporate protocols, such as IP, TCP, UDP, and/or the like.

The communication network 104 provides improved functionalities for joint initial access with terrestrial and non-terrestrial TRPs 102A and 102B (described in more detail later). In particular, the communication network 104 comprises one or more controlling devices 120 in communication with the TRPs 102 to provide various services such as voice, data, and other services to the UEs 114. The one or more controlling devices 120 of the communication network 114 may also serve as a gateway access between (i) the TRPs 102 or UEs 114 or both, and (ii) other networks (such as the PSTN 106, the Internet 108, and the other networks 110).

FIG. 2 is a simplified schematic diagram of the controlling device 120. As shown, the controlling device 120 comprises at least one processing unit 122 (also denoted “processor”), at least one network interface 124, one or more input/output components or interfaces 126, and at least one memory 128 (also denoted “storage device” hereinafter).

The processing unit 122 is configured for performing various processing operations and may comprise a microprocessor, a microcontroller, a digital signal processor, a field programmable gate array (FPGA), an application specific integrated circuit (ASIC), and/or the like.

The network interface 124 comprises a circuitry for directly or indirectly (that, via one or more intermediate devices) communicating with other devices such as the terrestrial TRPs 102A and non-terrestrial TRPs 102B, the PSTN 106, the Internet 108, and other networks 110 using suitable wired or wireless communication technologies and suitable protocols.

Each input/output component 126 enables interaction with a user or other devices in the communication system 100. Each input/output device 126 may comprise any suitable structure for providing information to or receiving information from a user and may be, for example, a speaker, a microphone, a keypad, a keyboard, a display, a touch screen, and/or the like.

Each memory 128 may comprise any suitable volatile and/or non-volatile storage and retrieval components such as random access memory (RAM), read only memory (ROM), hard disk, optical disc, subscriber identity module (SIM) card, solid-state memory modules, memory stick, secure digital (SD) memory card, and/or the like. The memory 128 may be used for storing instructions executable by the processing unit 122 and data used, generated, or collected by the processing unit 122 and/or the network interface 124. For example, the memory 126 may store software instructions or modules executable by the processing unit 122 for implementing some or all of the functionalities and/or embodiments of the controlling device 120 described herein. The memory 126 may also store coverage information of the TRPs 102 (described in more detail later) in, for example, a database thereof.

Referring back to FIG. 1, the TRPs 102 comprise a plurality of terrestrial TRPs 102A and a plurality of non-terrestrial TRPs 102B. Herein, a terrestrial TRP 102A is generally deployed on the ground (including on ground-based infrastructures such as buildings, towers, and/or the like). The terrestrial TRP 102A may typically comprise a base station and optionally other components such as one or more base station controllers (BSCs), radio network controllers (RNCs), relay nodes, elements, and/or the like. Each terrestrial TRP 102A (or more specifically the base station thereof) transmits and/or receives wireless signals within a particular geographic region or area (that is, a “cell” or a “coverage area”). A cell may be further partitioned into cell sectors, and a terrestrial TRP 102A may, for example, employ multiple transceivers to provide service to multiple cell sectors. In some embodiments, there may be established pico or femto cells where the radio access technology supports such. In some embodiments, multiple transceivers may be used for each cell, for example using multiple-input multiple-output (MIMO) technology.

As those skilled in the art understand, cellular coverage (that is, the coverage of the terrestrial TRPs 102A) typically varies depending on the regions. For example, cellular coverage is typically strong and widely available in regions with dense cellular infrastructure deployment; examples of such regions may be urban regions with high population density where carriers are more willing to deploy more cellular infrastructure. On the other hand, cellular coverage may be sparse and poorly available in regions with sparse cellular infrastructure deployment; examples of such regions may be rural or remote regions with low population density where carriers are less motivated to deploy cellular infrastructure.

On the other hand, a non-terrestrial TRP 102B is a TRP generally deployed above ground or in the space such as a communication satellite or a high altitude platform stations (HAPS) (for example, a drone, a balloon, an airship, an aircraft, or the like). In various embodiments, a non-terrestrial TRP 102B may be permanently or semi-permanently deployed (such as a non-terrestrial TRP 102B in the form of a communication satellite, a communication balloon or airship anchored at a fixed location, or the like), or may be temporarily deployed (for example, a non-terrestrial TRP 102B in the form of a drone, a balloon, or an airship temporarily deployed about a location) for supporting an anticipated intensive-communication event such as a concert, a game, or the like, wherein the deployment of the non-terrestrial TRP 102B may be cancelled after the event.

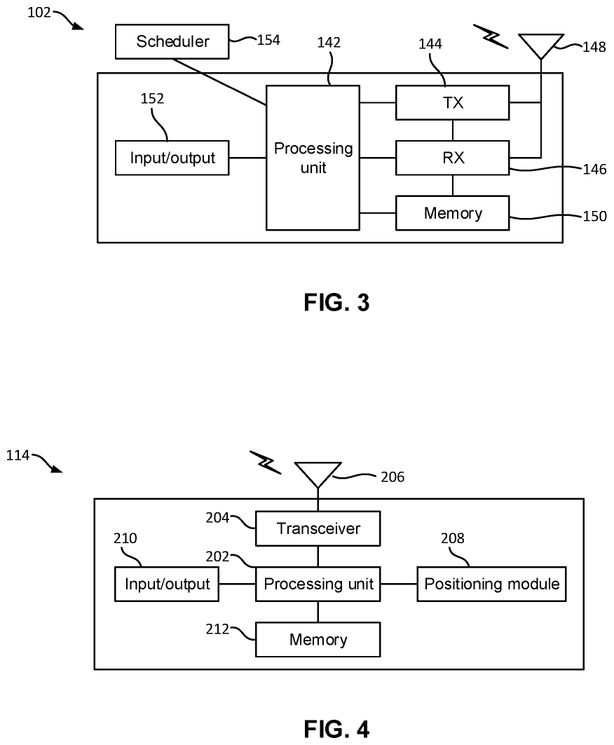

The terrestrial TRP 102A and non-terrestrial TRP 102B may have a similar structure although they may be different in some aspects such as their communication bandwidths, communication technologies, protocols, and/or the like. FIG. 3 is a simplified schematic diagram of a TRP 102. As shown, the TRP 102 comprises at least one processing unit 142, at least one transmitter 144, at least one receiver 146, one or more antennas 148, at least one memory 150, and one or more input/output components or interfaces 152. A scheduler 154 may be coupled to the processing unit 142. The scheduler 154 may be included within or operated separately from the TRP 102.

The processing unit 142 is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like.

Each transmitter 144 may comprise any suitable structure for generating signals for wireless transmission to one or more UEs 114 or other devices. Each receiver 146 may comprise any suitable structure for processing signals received wirelessly from one or more UEs 114 or other devices. Although shown as separate components, at least one transmitter 144 and at least one receiver 146 may be integrated and implemented as a transceiver. Each antenna 148 may comprise any suitable structure for transmitting and/or receiving wireless signals. Although a common antenna 148 is shown in FIG. 3 as being coupled to both the transmitter 144 and the receiver 146, one or more antennas 148 may be coupled to the transmitter 144, and one or more separate antennas 148 may be coupled to the receiver 146.

Each memory 150 may comprise any suitable volatile and/or non-volatile storage and retrieval components such as RAM, ROM, hard disk, optical disc, SIM card, solid-state memory modules, memory stick, SD memory card, and/or the like. The memory 150 may be used for storing instructions executable by the processing unit 142 and data used, generated, or collected by the processing unit 142. For example, the memory 150 may store software instructions or modules executable by the processing unit 142 for implementing some or all of the functionalities and/or embodiments of the TRP 102 described herein.

Each input/output component 152 enables interaction with a user or other devices in the system 100. Each input/output device 152 may comprise any suitable structure for providing information to or receiving information from a user and may be, for example, a speaker, a microphone, a keypad, a keyboard, a display, a touch screen, a network communication interface, and/or the like.

Referring back to FIG. 1, the TRPs 102 may communicate with the UEs 114 over one or more air interfaces 118 using any suitable wireless communication links such as radio frequency (RF), microwave, infrared (IR), and/or the like. The air interfaces 118 may utilize any suitable channel access methods such as time division multiple access (TDMA), frequency division multiple access (FDMA), orthogonal FDMA (OFDMA), single-carrier FDMA (SC-FDMA), code division multiple access (CDMA), wideband CDMA (WCDMA), and/or the like.

The air interfaces 118 may use any suitable radio access technologies such as universal mobile telecommunication system (UMTS), high speed packet access (HSPA), HSPA+(optionally including high speed downlink packet access (HSDPA), high-speed uplink packet access (HSUPA), or both), Long-Term Evolution (LTE), LTE-A, LTE-B, IEEE 802.11, 802.15, 802.16, CDMA2000, CDMA2000 1×, CDMA2000 EV-DO, IS-2000, IS-95, IS-856, global system for mobile communications (GSM), enhanced data rates for gsm evolution (EDGE), GSM EDGE radio access network (GERAN), 5G New Radio (5G NR), standard or non-standard satellite internet access technologies, and/or the like. Moreover, the communication system 100 may use multiple channel access functionality. Of course, other multiple access schemes and wireless protocols may be used.

Herein, a UE 114 generally refers to a wireless device that may join the communication system 100 via a joint initial access procedure (described in more detail later). In various embodiments, a UE 114 may be a wireless device used by a human or user (such as a smartphone, a cellphone, a personal digital assistant (PDA), a laptop, a computer, a tablet, a smart watch, a consumer electronics device, and/or the like. A UE 114 may alternatively be a wireless sensor, an Internet-of-things (IoT) device, a robot, a shopping cart, a vehicle, a smart TV, a smart appliance, or the like. Depending on the implementation, the UE 114 may be movable autonomously or under the direct or remote control of a human, or may be positioned at a fixed position. In some embodiments, a UE 114 may be a network device (such as a TRP 102, a wireless transmit/receive unit (WTRU), a mobile station, a fixed or mobile subscriber unit, a machine type communication (MTC) device, a device of the communication network 104, or the like) which is considered as a UE when it is powered on and joins the communication system 100 via the joint initial access procedure; and then acts as a network device after the joint initial access procedure is completed). In some embodiments, the UEs 114 may be multimode devices capable of operation according to multiple radio access technologies and incorporate multiple transceivers necessary to support such.

FIG. 4 is a simplified schematic diagram of a UE 114. As shown, the UE 114 comprises at least one processing unit 202, at least one transceiver 204, at least one antenna or network interface controller (NIC) 206, at least one optional positioning module 208, one or more input/output components 210, and at least one memory 212.

The processing unit 202 is configured for performing various processing operations such as signal coding, data processing, power control, input/output processing, or any other functionalities to enable the UE 114 to join the communication system 100 and operate therein. The processing unit 202 may also be configured to implement some or all of the functionalities and/or embodiments of the UE 114 described in this disclosure. The processing unit 202 may comprise a microprocessor, a microcontroller, a digital signal processor, a FPGA, or an ASIC.

The at least one transceiver 204 may be configured for modulating data or other content for transmission by the at least one antenna 206. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The positioning module 208 is configured for communicating with a plurality of global or regional positioning anchors. The positioning module 208 may use the transceiver 204 and antenna 206 for communicating with the positioning anchors, or may comprise separate transceiver and antenna for communicating with the positioning anchors. In some embodiments, the positioning anchors may be positioning devices such as navigation satellites and/or HAPS separated from the non-terrestrial TRPs 102B. For example, the navigation satellites may be satellites of a global navigation satellite system (GNSS) such as the Global Positioning System (GPS) of USA, Global'naya Navigatsionnaya Sputnikovaya Sistema (GLONASS) of Russia, the Galileo positioning system of the European Union, and/or the Beidou system of China. The navigation satellites may also be satellites of a regional navigation satellite system (RNSS) such as the Indian Regional Navigation Satellite System (IRNSS) of India, the Quasi-Zenith Satellite System (QZSS) of Japan, or the like. In some other embodiments, the positioning anchors may be devices (for example, navigation satellites and/or HAPS) acting as both positioning anchors for providing positioning reference signals and as non-terrestrial TRPs 102B. Other methods of determining the position of the UE 114 are also contemplated, such as a determination made by or more TRPs or NT-TRPs and communicated to the UE 114. In some embodiments, the UE 114 does not include a positioning module 208, and the functions of the positioning module 208 are performed by the processing unit 202 or some other processing unit.

The one or more input/output components 210 is configured for interaction with a user or other devices in the system 100. Each input/output component 210 may comprise any suitable structure for providing information to or receiving information from a user and may be, for example, a speaker, a microphone, a keypad, a keyboard, a display, a touch screen, a network communication interface, and/or the like.

The at least one memory 212 is configured for storing instructions executable by the processing unit 202 and data used, generated, or collected by the processing unit 202. For example, the memory 212 may store software instructions or modules executable by the processing unit 202 for implementing some or all of the functionalities and/or embodiments of the UE 114 described herein. Each memory 212 may comprise any suitable volatile and/or non-volatile storage and retrieval components such as AM, ROM, hard disk, optical disc, SIM card, solid-state memory modules, memory stick, SD memory card, and/or the like.

B. Joint Initial Access with Terrestrial and Non-Terrestrial TRPS

In the communication system 100, a UE 114 generally needs to execute an initial access procedure to establish a “connection” (that is, to establish communication) with a TRP 102 for joining the network system for communicating with other components thereof such as other UEs 114, the communication network 104, the PSTNs 106, the Internet 108, and other networks 110. The purpose of the initial access procedure is for the UE 114 to acquire downlink and uplink synchronization with the TRP 102.

For example, the initial access procedure defined since LTE comprises four physical-layer steps: (i) cell search, (ii) cell selection, (iii) system information acquisition, and (iv) random access. Initial access is typically initiated when the UE 114 is in the IDLE or INACTIVE state. After performing the initial access procedure, the UE 114 then transitions from the IDLE or INACTIVE state to the CONNECTED state. Upon completing the initial access procedure, the UE 114 is considered to have acquired both downlink and uplink synchronization with the TRP 102.

Herein, system information acquisition is defined as the step where the UE 114 receives the Physical Broadcast Channel (PBCH) and decodes the information that it carries. The information that the PBCH carries is a data packet called the Master Information Block (MIB), which contains essential system information such as the System Frame Number (SFN) and the configuration of the Physical Downlink Control Channel (PDCCH) used to receive System Information Block (SIB) messages. The reception of SIB messages by the UE 114 is also referred to as the UE 114 acquiring so-called Remaining System Information (RMSI).

Higher-layer signaling typically refers to parameter configuration provided by the communication network 104 to the UE 114. Such parameter configuration can be provided by the communication network 104 to the UE 114 through common signaling using MIB or SIB messages, another way is through dedicated signaling using the Radio Resource Control (RRC) protocol layer. Common signaling is typically used to provide parameter configuration to the UE 114 when the UE 114 is not in CONNECTED state while dedicated signaling is typically used to provide parameter configuration to the UE 114 when the UE 114 is in CONNECTED state.

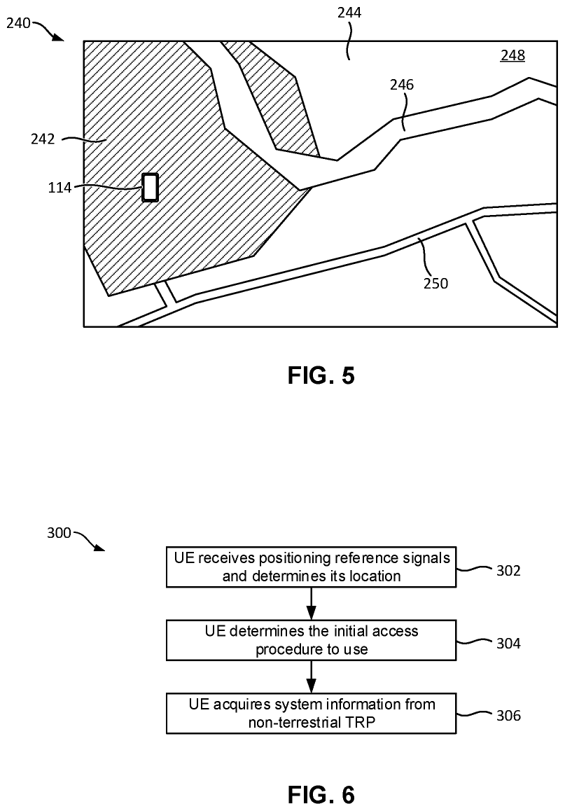

The communication system 100 allows UEs 114 to perform joint initial access with terrestrial and non-terrestrial TRPs 102A and 102B. As shown in FIG. 5, the communication network 104, or more specifically the one or more controlling devices 120 thereof, maintains a partition of the service area 240 thereof (such as one or more countries, one or more provinces, one or more states, one or more cities, or the like) which partitions or divides the service area 240 into one or more terrestrial initial-access zones 242 and one or more non-terrestrial initial-access zones 244.

The terrestrial initial-access zones 242 may be zones of the service area 240 with dense terrestrial TRPs 102A such as metropolitans, cities, towns, transportation hubs, and/or the like, wherein each terrestrial initial-access zone 242 is associated with one or more terrestrial TRPs 102A for providing communication services therewithin.

The non-terrestrial initial-access zones 244 may be zones of the service area 240 (such as major water bodies 246, rural areas 248, major highways 250, and/or the like) with sparse or no terrestrial TRPs 102A but covered by one or more non-terrestrial TRPs 102B, wherein each non-terrestrial initial-access zone 244 is associated with one or more non-terrestrial TRPs 102B for providing communication services therewithin. Some or all of non-terrestrial initial-access zones 244 may also be respectively associated with one or more terrestrial TRPs 102A for providing communication services therewithin.

In these embodiments, the communication network 104 stores coverage information such as a coverage map indicating the terrestrial initial-access zones 242, non-terrestrial initial-access zones 244, and related information thereof such as frequency bands, carrier bandwidth, synchronization rasters, and/or the like related to terrestrial and non-terrestrial TRPs 102A and 102B and positioning anchors.

FIG. 6 is a flowchart showing a joint initial access procedure 300 performed by the communication system 100 (and in particular, the UE 114 to join the communication system 100 and the communication network 104) for the initial access of the UE 114 utilizing terrestrial and non-terrestrial TRPs 102A and 102B, according to some embodiments of this disclosure. Herein, coverage information required by the UE 114 for performing the joint initial access procedure 300 may be predefined and stored in the SIM card used by the UE 114, or may be acquired by the UE 114 from the communication network 104 (described in more detail below).

At step 302, the UE 114 in the IDLE state receives positioning reference signals from positioning anchors. As the information of positioning anchors is available to the UE 114, the UE 114 may perform beamforming towards the positioning anchors to transmit or receive signals. The UE 114 determines its location based on the received positioning reference signals.

At step 304, the UE 114 determines whether it is in a terrestrial initial-access zone 242 or a non-terrestrial initial-access zone 244 based on its location and relevant coverage information, and subsequently determines whether to execute the terrestrial initial-access procedure (such as the cellular initial-access procedure) or the non-terrestrial initial-access procedure (such as the satellite-based initial-access procedure). Then, the UE 114 executes the determined initial-access procedure.

At step 306, the UE 114 communicates with one or more relevant non-terrestrial TRPs 102B to acquire common information such as system information (SI) therefrom. Herein common information refers to information commonly needed by all UEs 114 for joining the communication system 100. Such information may preferably be broadcast by non-terrestrial TRPs 102B because of their larger coverage compared to that of terrestrial TRPs 102A.

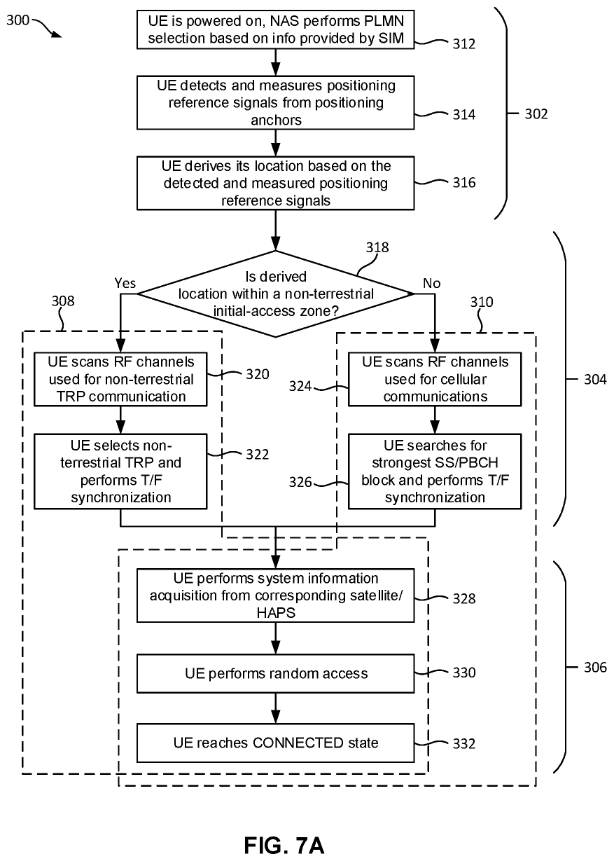

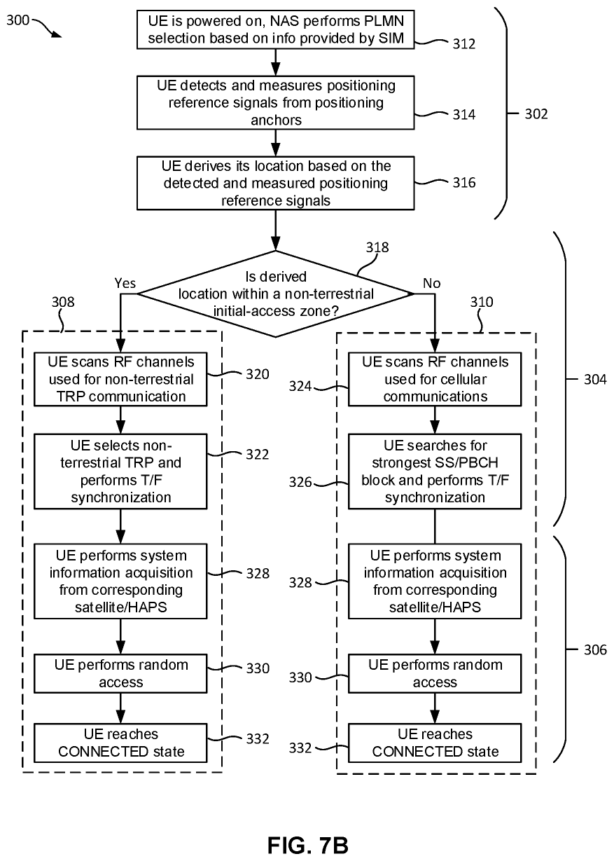

The joint initial access procedure 300 may comprise various detailed steps in various embodiments. For example, FIG. 7A shows the joint initial access procedure 300 in some embodiments. In these embodiments, the terrestrial and non-terrestrial initial-access zones 242 and 244 are predefined and the coverage information thereof may be stored in the SIM card and provided to the UE 114 to join the communication system 100. Those skilled in the art will appreciate that the predefined terrestrial and non-terrestrial initial-access zones 242 and 244 may be updated from time to time. The updated coverage information may be stored into the SIM cards to be installed to “new” UEs 114 and/or may be sent to the UEs 114 that have already joined the communication system 100 via updates (periodical and/or as needed).

As shown in FIG. 7A, steps 312 to 316 correspond to step 302 shown in FIG. 6, steps 318 to 326 correspond to step 304 shown in FIG. 6, and steps 328 to 332 correspond to step 306 shown in FIG. 6. Moreover, steps 320, 322, and 328 to 332 correspond to the non-terrestrial initial-access procedure 308, and steps 324, 326, and 328 to 332 correspond to the terrestrial initial-access procedure 310. In these embodiments, steps 328 to 332 are common steps of and shared by the non-terrestrial and terrestrial initial-access procedure 308 and 310. Those skilled in the art will appreciate that in some other embodiments, the steps 328 to 332 may be separately implemented in the non-terrestrial and terrestrial initial-access procedure 308 and 310, as shown in FIG. 7B.

At step 312, when the SIM card is inserted into the UE 114 and the UE 114 is powered on, the UE 114 executes the Non-Access Stratum (NAS) functions to perform public land mobile network (PLMN) selection based on information provided by the SIM card.

Then, the UE 114 detects and measures positioning reference signals from positioning anchors (step 314), and calculates or otherwise derives its location (for example, the three-dimensional (3D) coordinates) based on the detected and measured positioning reference signals (step 316).

At step 318, the UE 114 checks if the derived location thereof is within a non-terrestrial initial-access zone. If the derived location thereof is within a non-terrestrial initial-access zone (the YES branch of step 318), the UE 114 executes the non-terrestrial initial-access procedure 308. For example, the UE 114 may scan the RF channels used for non-terrestrial TRP communication (step 320), and select a non-terrestrial TRP 102B based on scan results (for example, selecting a non-terrestrial TRP 102B having the strongest signal detected by the UE 114) and performs time/frequency (T/F) synchronization (step 322). As will be described in more detail below, in some embodiments, the UE 114 may use stored information (such as frequency band information of non-terrestrial TRPs 102B) to simplify steps 320 and/or 322 (for example, selecting a non-terrestrial TRP 102B based on stored information and without scanning the RF channels used for non-terrestrial TRP communication).

The procedure 300 then goes to step 328.

At step 318, if the derived location thereof is not within a non-terrestrial initial-access zone (the NO branch of step 318), the UE 114 executes the terrestrial initial-access procedure 310. For example, the UE 114 may scan the RF channels used for terrestrial TRP communication such as RF channels used for cellular communication (step 324), and select a terrestrial TRP 102A based on scan results (for example, selecting a terrestrial TRP 102A having the strongest Synchronization Signal Physical Broadcast Channel (SS/PBCH) block) and performs T/F synchronization (step 326). As will be described in more detail below, in some embodiments, the UE 114 may use stored information (such as frequency band information of terrestrial TRPs 102A) to simplify steps 324 and/or 326 (for example, selecting a terrestrial TRP 102A based on stored information and without scanning the RF channels used for cellular communication).

The procedure 300 then goes to step 328.

At step 328, the UE 114 performs common-information acquisition (such as acquisition of the SI, as described above) from a non-terrestrial TRP 102B. In some embodiments, the non-terrestrial TRP 102B used for common-information acquisition may be the non-terrestrial TRP 102B selected at step 322 if the procedure 300 is branched from the YES branch of step 318, or may be a randomly selected non-terrestrial TRP 102B covering the location of the UE 114 if the procedure 300 is branched from the NO branch of step 318. In some alternative embodiments, the non-terrestrial TRP 102B used for common-information acquisition may be a detectable non-terrestrial TRP 102B with signals received by the UE 114 exceeding a predefined threshold, the best characteristics detected by the UE 114 (such as the highest RSRP, the highest RSRQ, or the highest SINR), or the like.

At step 330, the UE 114 performs random access. The UE 114 then enters the CONNECTED state (step 332) and the procedure 300 is completed.

The technical benefits of the joint initial access procedure 300 shown in FIGS. 7A and 7B may include:
efficient initial access through selection (by the UE 114) of a suitable initial-access procedure (that is, the terrestrial initial-access procedure or the non-terrestrial initial-access procedure) using the coverage information provided by the communication system 100 via SIM cards; and
reliable SI acquisition by leveraging non-terrestrial TRPs 102B which generally have much larger coverage (compared to that of terrestrial TRPs 102A) and are more suitable for broadcast channel reception such as paging/SI reception.

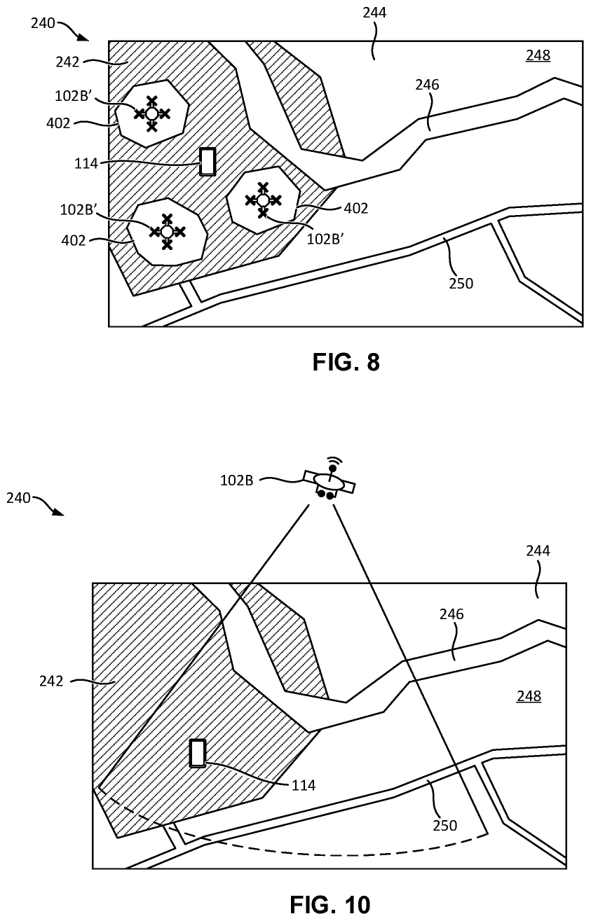

FIG. 8 shows a service area 240 of the communication system 100, according to some embodiments of this disclosure. In these embodiments, the communication system 100 partitions the service area 240 into terrestrial and non-terrestrial initial-access zones 242 and 244 in a manner similar to that shown in FIG. 5. However, in these embodiments, one or more additional non-terrestrial TRPs 102B′ such as one or more drones, one or more balloons, one or more airships, one or more aircrafts, and/or the like are deployed in some “hot spots” of the service area 240 (temporarily or on an on-demand basis) for managing traffic congestions in the terrestrial and non-terrestrial TRPs related to those hot spots. Each of the additional non-terrestrial TRPs 102B′ provides a respective coverage area which may be defined as an additional non-terrestrial initial-access zone 402.

Similar to the embodiments shown in FIGS. 7A and 7B, the terrestrial and non-terrestrial initial-access zones 242 and 244 are predefined and the coverage information thereof may be stored in the SIM card and provided to the UE 114 to join the communication system 100. When one or more additional non-terrestrial TRPs 102B′ are deployed, a component of the system 100, such as the communication network 104, base stations, a part of the radio access network (RAN) infrastructure, and/or the like, stores the coverage information of the corresponding additional non-terrestrial initial-access zones 402, and provides it to the UE 114 via updated SI. In some embodiments, the information of the initial-access zones such as the additional non-terrestrial initial-access zones 402 may be provided by base stations using so-called higher-layer signaling (which corresponds to the radio resource control layer in the 5G NR standard). Herein, higher-layer signaling refers to transmitting and receiving messages for controlling devices in the medium access control (MAC) layer and higher layers, such as radio resource control (RRC) signaling for transmitting/receiving RRC messages and MAC signaling for transmitting/receiving MAC control elements.

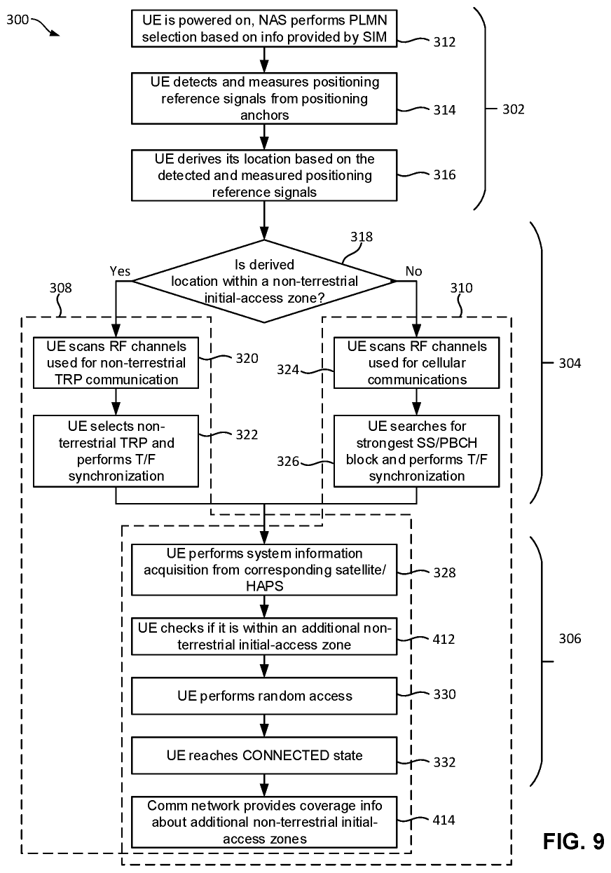

A UE 114 in an additional non-terrestrial initial-access zone 402 may transition from the IDLE state to the CONNECTED state via an initial access procedure and leverage the non-terrestrial TRP 102B′ of the additional non-terrestrial initial-access zone 402 the UE 114 is therewithin. FIG. 9 shows the joint initial access procedure 300 in these embodiments.

The joint initial access procedure 300 in these embodiments is similar to that shown in FIGS. 7A and 7B except having two additional steps 412 and 414. The description of the same steps is not repeated.

In fact, when the UE 114 performs common-information acquisition (such as acquisition of the SI, as described above) from a non-terrestrial TRP 102B (step 328), the SI received by the UE 114 contains the coverage information of the additional non-terrestrial TRPs 102B′ and their non-terrestrial initial-access zones 402. Then at step 412, the UE 114 may check if it is within an additional non-terrestrial initial-access zone 402. If yes, the UE 114 may select the non-terrestrial initial-access zone 402; otherwise, the UE 114 maintains its previously determined TRP selection. The procedure 300 then goes to step 330.

Alternatively, the UE 114 at step 412 may scan RF channels used for communication with the additional non-terrestrial TRPs 102B′ and select the additional non-terrestrial TRP with the strongest signal.

As described above, the joint initial access procedure 300 is completed after the UE 114 transitioned to the CONNECTED state (step 332). The communication system 100 may adjust the additional non-terrestrial TRPs 102B′ such as adding one or more new additional non-terrestrial TRPs 102B′, removing one or more existing additional non-terrestrial TRPs 102B′, moving one or more existing additional non-terrestrial TRPs 102B′ to other locations, and/or the like.

Subsequently, at step 414, the communication network 104 updates the coverage information (which includes the coverage information of the updated additional non-terrestrial TRPs 102B′ and their additional non-terrestrial initial-access zones 402) and broadcasts updated SI having the updated coverage information immediately, periodically, semi-statically, or as needed. After receiving the updated SI, The UE 114 may make new selection of TRPs.

Similar to the embodiments described above, the UE 114 performs common-information acquisition from a non-terrestrial TRP 102B which may be the non-terrestrial TRP 102B selected at step 322, a randomly selected non-terrestrial TRP 102B covering the location of the UE 114, or a non-terrestrial TRP 102B with the strongest signal detected by the UE 114.

The technical benefits of the embodiments shown in FIG. 9 may include:
efficient initial access through selection (by the UE 114) of a suitable initial-access procedure (that is, the terrestrial initial-access procedure or the non-terrestrial initial-access procedure) using the coverage information provided by the communication system 100 via SIM cards;
additional flexibility and efficiency achieved by leveraging additional non-terrestrial TRPs 102B′ using the coverage information provided by the communication system 100 via updated SI; and
reliable SI acquisition by leveraging non-terrestrial TRPs 102B which generally have much larger coverage (compared to that of terrestrial TRPs 102A) and are more suitable for broadcast channel reception such as paging/SI reception.

In some embodiments, the UE 114 may leverage previously stored coverage information for executing the initial access procedure after the UE 114 “wakes up” from “sleep” (that is, from the IDLE state).

For example, FIG. 10 shows a service area 240 of the communication system 100, according to some embodiments of this disclosure. In these embodiments, the communication system 100 partitions the service area 240 into terrestrial and non-terrestrial initial-access zones 242 and 244 in a manner similar to that shown in FIG. 5. One or more non-terrestrial TRPs 102B such as one or more satellites provide SI for all UEs 114 in the service area 240.

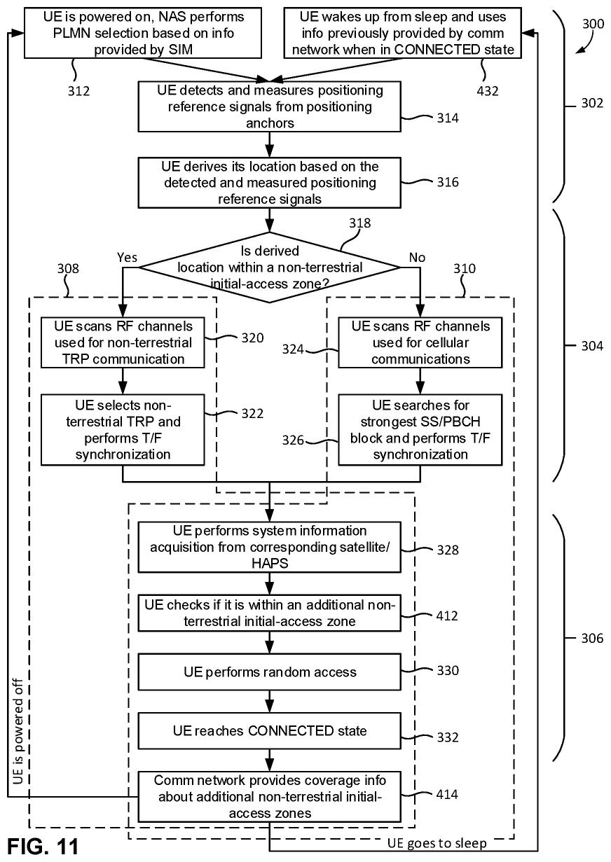

FIG. 11 shows the joint initial access procedure 300 in these embodiments. The joint initial access procedure 300 in these embodiments is similar to that shown in FIG. 9 except having an additional step 432 and extra flow logics. The description of the same steps is not repeated.

As shown in FIG. 11, the UE 114 uses the coverage information stored in its SIM card and goes through steps 312 to 414 as described above to power on and join the communication system 100, wherein the UE 114 receives SI from the communication network 104 (at step 328 or 414), wherein the received SI comprises updated coverage information of the terrestrial and non-terrestrial TRPs 102A and 102B. The UE 114 stores the coverage information in the memory 212 thereof.

After step 414, the UE 114 may go to “sleep” (that is, the IDLE state). As those skilled in the art will appreciate, when in the IDLE state, the UE 114 stops most operations. However, the stored coverage information is still maintained.

At step 432, when the UE 114 wakes from the IDLE state, the UE 114 retrieves the stored coverage information and then uses the retrieved coverage information to go through steps 324 to 414 to transition to the CONNECTED state.

Alternatively, if the UE 114 is powered off after step 432, when the UE 114 is later powered on, the procedure 300 goes to step 312 to retrieve coverage information from the SIM card and starts the initial access procedure.

Similar to the embodiments described above, the UE 114 performs common-information acquisition from a non-terrestrial TRP 102B which may be the non-terrestrial TRP 102B selected at step 322, a randomly selected non-terrestrial TRP 102B covering the location of the UE 114, or a non-terrestrial TRP 102B with the strongest signal detected by the UE 114.

The technical benefits of the embodiments shown in FIG. 11 may include:
efficient initial access through selection (by the UE 114) of a suitable initial-access procedure (that is, the terrestrial initial-access procedure 310 or the non-terrestrial initial-access procedure 308) using the coverage information provided by the communication system 100 via SIM cards;
reliable SI acquisition by leveraging non-terrestrial TRPs 102B which generally have much larger coverage (compared to that of terrestrial TRPs 102A) and are more suitable for broadcast channel reception such as paging/SI reception; and
additional flexibility and efficiency achieved by storing updated coverage information in UEs 114.

By using the joint initial access procedure 300 shown in FIG. 11, the UE 114 may perform a simplified terrestrial initial-access procedure (such as a simplified cellular-based initial-access procedure) with the assistance of non-terrestrial TRP 102B.

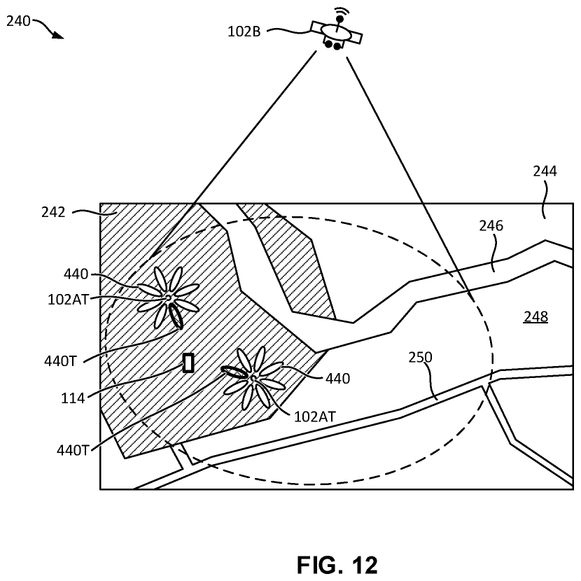

For example, when the UE 114 is powered on, it goes through steps 312 to 414 to join the communication system 100 and transition to the CONNECTED mode. Referring to FIG. 12, the communication network 104 may then determine one or more target terrestrial TRPs 102AT associated with the UE 114, and provide the UE 114 with the information of the one or more target terrestrial TRPs 102AT via a terrestrial TRP 102A or a non-terrestrial TRP 102B. Herein, the one or more target terrestrial TRPs 102AT may be the terrestrial TRP 102A that the UE 114 is currently connected thereto, or one or more terrestrial TRPs 102A with signals received by the UE 114 exceeding a predefined threshold, or one or more terrestrial TRPs 102A with the best characteristics detected by the UE 114 (such as the highest RSRP, the highest RSRQ, or the highest SINR). The information of the one or more target terrestrial TRPs 102AT that is provided by the communication network 104 may comprise the coverage information of the one or more target terrestrial TRPs 102AT and other relevant information thereof such as the Physical Cell Identity (PCI) and beamforming information of the one or more target terrestrial TRPs 102AT (such as their beams 440 and the target beams 440T thereof). The UE 114 stores the information of the one or more target terrestrial TRPs 102AT in its memory 128.

As those skilled in the art understand, beamforming is a signal processing technique for directional signal transmission or reception. By using beamforming, a wireless signal may be transmitted towards a specific direction (instead of transmitting the wireless signal from a broadcast antenna towards all directions when no beamforming is used). Beamforming may be achieved by using, for example, a plurality of transmitters with controlled phase and relative amplitude of the signal at each transmitter, such that the signals transmitted from the plurality of transmitters are constructive along the desired directions and destructive along undesired directions.

Referring back to FIG. 11, the UE 114 may go to the IDLE state. When the UE 114 wakes up from the IDLE state, the UE 114 may use the stored information of the one or more target terrestrial TRPs 102AT to perform simplified initial access including:
Time/Frequency synchronization with the target terrestrial TRP 102AT or a selected one of a plurality of target terrestrial TRPs 102AT: Because the PCI is provided to the UE 114, the UE 114 does not need to perform cell search or cell selection. Moreover, as beamforming information of target terrestrial TRPs 102AT is also provided, the UE 114 does not need beam-sweeping or only needs to perform limited beam-sweeping thereby saving beam-sweeping time.
Random access with the target terrestrial TRP 102AT or a selected one of a plurality of target terrestrial TRPs 102AT: Because SI acquisition is performed based on non-terrestrial TRPs 102B, the UE 114 simply completes initial access by performing random access with the target terrestrial TRP 102AT or a selected one of a plurality of target terrestrial TRPs 102AT.

By using target terrestrial TRPs 102AT the technical benefits of these embodiments may include:
Simplified initial access, wherein with assistance of non-terrestrial TRPs 102B, the UE 114 may perform the simplified terrestrial initial-access procedure using the information of the target terrestrial TRPs 102AT; and
reliable SI acquisition by leveraging non-terrestrial TRPs 102B which generally have much larger coverage (compared to that of terrestrial TRPs 102A) and are more suitable for broadcast channel reception such as paging/SI reception.

With above description, those skilled in the art will appreciate that, in various embodiments, the communication system 100 disclosed herein (i) enables the UE 114 to receive positioning reference signals and use the received positioning reference signals to determine its location, (ii) defines terrestrial and non-terrestrial initial-access zones and provides the coverage information of the terrestrial and non-terrestrial initial-access zones and the coverage information of the corresponding terrestrial and non-terrestrial TRPs 102A and 102B to the UE 114 to help the UE 114 determine which one of the terrestrial initial-access procedure 310 and the non-terrestrial initial-access procedure 308 to be used for completing the joint initial access procedure; and (iii) enables the UE 114 to perform the simplified initial access using SI acquired from non-terrestrial TRPs 102B, without cell search or cell selection, and with reduced beam-sweeping time.

In some embodiments, the communication system 100 stores non-terrestrial frequency band information as part of the coverage information in a SIM card of the UE 114, wherein the SIM card comprises a static or non-volatile memory for information storage. In these embodiments, the non-terrestrial frequency band information is the frequency band information of the one or more positioning anchors (such as one or more non-terrestrial TRPs 102B (for example, drones, balloons, satellites, and/or the like) that also act as positioning anchors). The UE 114 may use the non-terrestrial frequency band information to receive positioning reference signals transmitted from the one or more positioning anchors for determining the position of the UE 114. Each of these positioning reference signals may be defined using a pseudo-random sequence such as a Gold sequence and the parameter value initializing this pseudo-random sequence (denoted “initial-sequence parameter value” hereinafter) is a number belonging to a group of numbers used by the positioning anchors using the same frequency band to transmit positioning reference signals.

For example, the group of numbers used by the positioning anchors to initialize the pseudo-random sequences they transmit may be, for example, {N, N+1, . . . , N+M} where N (N is an integer and N≥0) designates the lowest initializer value that may be used by the pseudo-random sequence, and M (M is an integer and M>0) designates the total number of pseudo-random sequences that may be used by positioning anchors.

In some embodiments, the communication system 100 may store in a SIM card (which comprises a static memory for information storage) of the UE 114 the initial-sequence parameter value information as part of the coverage information, for initializing pseudo-random sequences used by one or more positioning anchors to transmit positioning reference signals. Then, the UE 114 may use the initial-sequence parameter value information retrieved from the SIM card to detect and measure positioning reference signals whose pseudo-random sequences are initialized using the initial sequence parameter value information.

In some embodiments, the communication system 100 stores beamforming information of one or more positioning anchors as part of the coverage information in a SIM card of the UE 114, wherein the positioning anchor information may include, for example, predefined azimuth and zenith angles of beams of the positioning reference signals of the one or more positioning anchors with respect to a reference coordinate system. Then, the UE 114 may use the beamforming information (such as the azimuth and zenith angles) for steering its beam towards the corresponding positioning anchor, so that the UE 114 may receive and detect positioning reference signals transmitted by the one or more positioning anchors. Other examples of beamforming information include beam pair link indexes, wherein different beam pairs are associated with a logical index I (I is an integer and I≥0).

In some embodiments, the communication system 100 stores positioning-anchor position information in a SIM card of the UE 114. The positioning-anchor position information may include, for example, predefined coordinates of the positioning anchors with respect to a reference coordinate system (which may be the same reference coordinate system as that used for the information of the azimuth and zenith angles described above). Then, the UE 114 may use the position information of the positioning anchors to determine one or more positioning anchors that the UE 114 is able to detect the positioning reference signals thereof (for example, one or more positioning anchors within the range of line-of-sight with the UE 114), and use the determined one or more positioning anchors to derive the position information of the UE 114.

In some embodiments, the UE 114 has the capability to receive positioning reference signals from positioning anchors on certain predefined non-terrestrial frequency bands. Such a capability may be defined, for example, as a one-bit capability parameter that is signaled by the UE 114 to the communication network 104 as part of, for example, capability reporting. Such predefined non-terrestrial frequency bands used by positioning anchors to transmit positioning reference signals may be defined in technical specifications such as in 4G LTE or 5G NR. In these embodiments, the UE 114 may scan for non-terrestrial RF channels (where an RF channel is defined as a radio frequency with a given frequency bandwidth in a given frequency band) on one or more of the non-terrestrial frequency bands that the UE 114 is capable of scanning, for example, from the lowest frequency band to the highest frequency band or using other implementation-specific methods, to detect and receive positioning reference signals for determining the position of the UE 114.

In some embodiments, the UE 114 has the capability to receive a predefined number of positioning reference signals from positioning anchors in the same time unit, wherein a time unit may be a duration in seconds, milli-seconds, micro-seconds, or nano-seconds, a duration of an OFDM symbol, a duration of a group of OFDM symbols, a duration of a CDMA chip, a duration of a group of CDMA chips, or the like. Such a capability may be defined, for example, as a one-bit capability parameter that is signaled by the UE 114 to the communication network 104 as part of, for example, capability reporting. Positioning anchors may send one or more positioning reference signals over a given non-terrestrial frequency band using suitable multiple-access technologies such as frequency-division multiple-access technologies, code-division multiple-access technologies, and/or the like, and there may be one or more positioning anchors transmitting positioning reference signals over a given non-terrestrial frequency band.

In some embodiments, the communication system 100 provides non-terrestrial frequency band information to the UE 114 using RRC signaling (also called higher-layer signaling), wherein the UE 114 stores information of the RRC signaling in its memory. The UE 114 may go to sleep (that is, transitioning from the CONNECTED state to the IDLE state). After the UE 114 wakes up, the UE 114 may use the non-terrestrial frequency band information stored in its memory to receive positioning reference signals transmitted from positioning anchors (for example, non-terrestrial TRPs such as drones, balloons, satellites, and/or the like that also act as positioning anchors). The UE 114 then derives its geographic coordinates based on the positioning reference signals it was able to detect, and proceeds to select one of the terrestrial and non-terrestrial initial-access procedures.

In some embodiments, the communication system 100 provides non-terrestrial frequency band information and beamforming information (for example, predefined azimuth of zenith angles with respect to a given coordinate system) to the UE 114 using RRC signaling (also called higher-layer signaling), wherein the UE 114 stores the RRC signaling in its memory. The UE 114 may go to sleep (that is, transitioning from the CONNECTED state to the IDLE state). After the UE 114 wakes up, the UE 114 may use the stored the non-terrestrial frequency band information to receive positioning reference signals transmitted from positioning anchors (for example, non-terrestrial TRPs such as drones, balloons, satellites, and/or the like that also act as positioning anchors). The UE 114 uses the beamforming information to steer its beam towards the direction indicated by the azimuth and zenith angles to detect positioning reference signals transmitted from positioning anchors. The UE 114 then derives its geographic coordinates based on the positioning reference signals it was able to detect and proceeds to select one of the terrestrial and non-terrestrial initial-access procedures.

In some embodiments, the communication system 100 provides non-terrestrial frequency band information, beamforming information (for example, predefined azimuth of zenith angles with respect to a given coordinate system), and reference signal information (for example, a cell-specific identifier, a group-specific identifier, a user-specific identifier, and/or the like) to the UE 114 using RRC signaling (also called higher-layer signaling), wherein the UE 114 stores the RRC signaling in its memory. The UE 114 may go to sleep (that is, transitioning from the CONNECTED state to the IDLE state). After the UE 114 wakes up, the UE 114 may use the stored non-terrestrial frequency band information to receive positioning reference signals transmitted from positioning anchors (for example, non-terrestrial TRPs such as drones, balloons, satellites, and/or the like that also act as positioning anchors). The UE 114 uses the beamforming information to steer its beam towards the direction indicated by the azimuth and zenith angles to detect reference signals. The UE 114 uses the reference signal information to detect the corresponding reference signals using the cell-specific, group-specific, or user-specific identifier. The UE 114 then derives its geographic coordinates based on the reference signals it was able to detect and proceeds to select one of the terrestrial and non-terrestrial initial-access procedures.

In some embodiments, the UE 114 has the capability to select and execute one of the terrestrial and non-terrestrial initial-access procedures and the UE 114 does not signal this capability to the communication system 100. The communication system 100 assumes that the UE 114 is capable of receiving and detecting both terrestrial and non-terrestrial reference signals and is capable of selecting and executing one of the terrestrial and non-terrestrial initial-access procedures in order to access the communication system 100. In this example, the capability of selecting and executing one of the terrestrial and non-terrestrial initial-access procedures is a mandatory feature of the UE 114, that is, all UEs 114 are required to support this feature.

In some embodiments, the UE 114 has the capability to select and execute one of the terrestrial and non-terrestrial initial-access procedures and it signals this capability to the communication system 100 as part of establishing a connection with the communication system 100. The UE 114 may perform one of the terrestrial and non-terrestrial initial-access procedures as the default procedure upon first accessing the communication system 100. After accessing the communication system 100, the UE signals its capability to the communication system 100 as part of establishing a connection with the communication system 100, and the communication system 100 may provide signaling to the UE 114 that configures the UE 114 such that the UE 114 may execute either one of the terrestrial or the non-terrestrial initial-access procedure, depending on, for example, the location of the UE 114. In this example, the capability of selecting and executing one of the terrestrial and non-terrestrial initial-access procedures is an optional feature of the UE 114; for example, only those UEs 114 that indicate their support of this feature may be determined by the communication system 100 as the UEs 114 who support this feature.

In some embodiments, the UE 114 has the capability to select and execute one of the terrestrial and non-terrestrial initial-access procedures and store a maximum of N1 non-terrestrial initial-access zones in its memory, where N1 is an integer and N1>0. After accessing the communication system 100, the UE 114 signals such capability to the communication system 100, and the communication system 100 may provide signaling to the UE 114 about a maximum of N1 non-terrestrial initial access zones. The UE 114 may go to sleep (that is, transitioning from the CONNECTED state to the IDLE state). After the UE 114 wakes up, the UE 114 may select one from the N1 non-terrestrial access zones and execute the non-terrestrial initial-access procedure.

In some embodiments, the UE 114 has the capability to select and execute one of the terrestrial and non-terrestrial initial-access procedures and store a maximum of N2 terrestrial beamforming information (that is, the terrestrial beamforming information of N2 usable terrestrial communication nodes) in memory, where N2 is an integer and N2>0. After accessing the communication system 100, the UE signals such capability to the communication system 100, and the communication system 100 may provide signaling to the UE 114 about a maximum of N2 terrestrial beam information in memory. The UE 114 may go to sleep (that is, transitioning from the CONNECTED state to the IDLE state). After the UE 114 wakes up, the UE 114 may scan for the terrestrial beams whose information was provided by the communication system 100 and may select one from the N2 terrestrial beams and execute the initial-access procedure using the selected terrestrial beam.

In some embodiments, the UE 114 may go into sleep mode. Sleep mode is defined as a mode of operation where the UE 114 only applies procedures to perform SI acquisition and positioning reference signal reception from positioning anchors. Another form of sleep mode refers to a mode of operation where the UE 114 only applies procedures to perform SI acquisition and synchronization signal reception (for example, SS/PBCH blocks) from terrestrial and/or non-terrestrial TRPs 102.

In some embodiments, the UE 114 may go into deep sleep mode. Deep sleep mode is defined as a mode of operation where the UE 114 only applies procedures to receive positioning reference signals from positioning anchors. Another form of deep sleep mode refers to a mode of operation where the UE 114 only applies procedures to synchronization signal reception (for example, SS/PBCH blocks) from terrestrial and/or non-terrestrial TRPs 102.

In some embodiments, the UE 114 goes to sleep mode in order to reduce power consumption and increase battery life. The communication network 104 may provide higher-layer signaling to the UE 114 indicating which positioning anchors to receive positioning reference signals from (for example, SS/PBCH blocks, GNSS, and/or the like). This allows the UE 114 to continue determining its geographic location while it is in sleep mode and upon waking up from sleep mode (due to, for example, higher-layer signaling provided by the communication network 104 or due to incoming/outgoing UE-specific traffic data) the UE 114 then immediately selects and executes one of terrestrial and non-terrestrial initial-access procedures as described above.

In some embodiments, the UE 114 goes to a deep sleep mode in order to further reduce power and increase battery life. The communication network 104 may provide higher-layer signaling to the UE 114 indicating which positioning anchors to receive positioning reference signals from (for example, SS/PBCH blocks, GNSS). This allows the UE 114 to continue determining its geographic location while it is in deep sleep mode and upon waking up from deep sleep mode (due to, for example, higher-layer signaling provided by the communication network 104 or due to incoming/outgoing UE-specific traffic data). Following this connection blockage with the terrestrial TRP, the UE 114 then attempts to re-establish its connection with the communication network 104 by performing system re-entry by selecting and executing one of terrestrial and non-terrestrial initial-access procedures as described above.

As those skilled in the art will appreciate, sleep mode, deep sleep mode, and the like are the modes that the UE 114 may enter in order to reduce power consumption and increase battery life when it is not actively performing communication or computation functions. In various embodiments, such modes may be denoted with various names and the conditions under which the UE 114 may enter may vary. However, as those skilled in the art will also appreciate and will understand from above examples, the UE 114 in the sleep mode or a similar mode may still maintain a minimum set of operations. Equivalently, this means that the UE 114 may turn off all its functions except for those functions which are part of the minimum set of operations that the UE 114 is required to run while it is in sleep mode. With the higher-layer signaling provided by the communication network 104, the UE 114 may continuously determine and update its geographic location, and when waking up, may quickly re-join the communication system 100 by selecting and executing one of terrestrial and non-terrestrial initial-access procedures as described above. Similarly, one or more of the embodiments described herein may be used in any combination in order to enable the UE 114 to select and execute one of terrestrial and non-terrestrial initial-access procedures.

In some embodiments, the UE 114 attempts to perform system re-entry. System re-entry is defined as the procedure whereby the UE 114 selects and executes one of terrestrial and non-terrestrial initial-access procedures, in order to re-establish its connection with the communication network 104. System re-entry can be initiated by the UE 114 for a variety of reasons, as described in the paragraphs below.

In some embodiments, when the UE 114 suffers from a connection blockage due to, for example, shadowing from a large building or a beam blockage event, the communication network 104 may provide higher-layer signaling to the UE 114 indicating information about non-terrestrial TRPs 102B, where this higher-layer signaling information may be non-terrestrial frequency band information, non-terrestrial reference signal information (for example, time and frequency resource information and sequence initializer parameter information), beamforming information (for example, azimuth and zenith angle information) in order for the UE 114 to steer its receive beam in the indicated direction to detect and measure non-terrestrial reference signals. As a result of this connection blockage, the UE 114 drops its connection with the terrestrial TRP 102A and the UE 114 leaves the CONNECTED state and goes back to IDLE state. Following this connection blockage with the terrestrial TRP 102A, the UE 114 then attempts to re-establish its connection with the communication network 104 by performing system re-entry by selecting and executing a non-terrestrial initial-access procedure. The selection of the non-terrestrial initial-access procedure is based on the information of non-terrestrial TRPs 102B provided by the communication network 104.

In some embodiments, when the UE 114 suffers from a connection blockage due to, for example, shadowing from a large building or a beam blockage event, the communication network 104 may provide higher-layer signaling to the UE 114 further indicating information about beam blockage events, in addition to information about non-terrestrial TRPs 102B. Such beam blockage events are defined using a terrestrial reference signal information (for example, a reference signal identifier, time and frequency resource information, sequence generation information, azimuth and zenith angles for beamforming), a RSRP or RSRQ or SINR threshold, and a time duration for which the condition to trigger the event must be satisfied (for example, the RSRP of the indicated reference signal is below a certain threshold). If the beam blockage event is triggered, then the UE 114 considers that a connection blockage has happened and the UE 114 attempts to re-establish its connection with the communication network 104 by performing system re-entry by selecting and executing the non-terrestrial initial-access procedure. The selection of the non-terrestrial initial-access procedure is based on the information of non-terrestrial TRPs 102B provided by the communication network 104.

In above embodiments, the communication system 100 stores coverage information in a SIM card of the UE 114, wherein the SIM card comprises a static or non-volatile memory for information storage. In other embodiments, the coverage information may be stored in any suitable static memory of the UE 114 such as an eSIM integrated with the UE 114, a wireless internet stick (i.e., a wireless internet device that may be plugged to a host device such as a computer or laptop for providing wireless internet functionality thereto), and/or the like.

In above embodiments, the communication system 100 is a system combining terrestrial communication networks with non-terrestrial communication networks, such as combining cellular networks with satellite communication networks. In some embodiments, the terrestrial communication networks may comprise, or alternatively be, other radio access networks such as WI-FI™ networks.

Although embodiments have been described above with reference to the accompanying drawings, those of skill in the art will appreciate that variations and modifications may be made without departing from the scope thereof as defined by the appended claims.

1. An apparatus comprising a processing coupled a memory which storing instructions, when executed, cause the apparatus to perform a method for the apparatus to join into a communication system, the method comprising:
selecting one of a terrestrial initial-access procedure or a non-terrestrial initial-access procedure based on a position of the user equipment; and
executing the selected initial access procedure for joining the apparatus into the communication system.

2. The apparatus of claim 1, wherein said selecting the one of the terrestrial initial-access procedure or the non-terrestrial initial-access procedure based on the position of the apparatus comprises:
obtaining coverage information of a service area; and
selecting the one of the terrestrial initial-access procedure or the non-terrestrial initial-access procedure based on the coverage information and the position of the apparatus.

3. The apparatus of claim 2, wherein said selecting the one of the terrestrial initial-access procedure or the non-terrestrial initial-access procedure based on the coverage information and the position of the apparatus comprises:
identifying one or more terrestrial initial-access zones and one or more non-terrestrial initial-access zones using the obtained coverage information;
receiving positioning reference signals from a plurality of positioning anchors;
determining a location of the apparatus based on the received positioning reference signals;
determining, from the one or more terrestrial initial-access zones and the one or more non-terrestrial initial-access zones, a zone thereof that the apparatus is located therewithin based on the determined location thereof and the coverage information; and
selecting the one of the terrestrial initial-access procedure or the non-terrestrial initial-access procedure based on the determined zone.

4. The apparatus of claim 3, wherein the terrestrial initial-access procedure comprises:
selecting a communication node from one or more identified terrestrial communication nodes associated with the determined zone; and
establishing communication between the apparatus and the selected communication node for joining the apparatus into the communication system.

5. The apparatus of claim 4, wherein said selecting the communication node from the one or more identified terrestrial communication nodes associated with the determined zone comprises:
scanning radio-frequency (RF) channels associated with the one or more identified terrestrial communication nodes for identifying the one or more identified terrestrial communication nodes;
selecting the communication node from the identified one or more identified terrestrial communication nodes; and
performing time and frequency synchronization between the apparatus and the selected communication node.

6. The apparatus of claim 2, wherein the non-terrestrial initial-access procedure comprises:
selecting a communication node from one or more identified non-terrestrial communication nodes associated with the determined zone; and
establishing communication between the apparatus and the selected communication node for joining the apparatus into the communication system.

7. The apparatus of claim 6, wherein said selecting the communication node from the one or more identified non-terrestrial communication nodes associated with the determined zone comprises:
scanning RF channels associated with the one or more identified non-terrestrial communication nodes for identifying the one or more identified non-terrestrial communication nodes;
selecting the communication node from the identified one or more identified non-terrestrial communication nodes; and
performing time and frequency synchronization between the apparatus and the selected communication node.

8. A method for a user equipment to join into a communication system, the method comprising:
selecting one of a terrestrial initial-access procedure and a non-terrestrial initial-access procedure based on a position of the user equipment; and
executing the selected initial access procedure for joining the user equipment into the communication system.

9. The method of claim 8, wherein said selecting the one of the terrestrial initial-access procedure and the non-terrestrial initial-access procedure based on the position of the user equipment comprises:
obtaining coverage information of a service area; and
selecting the one of the terrestrial initial-access procedure and the non-terrestrial initial-access procedure based on the coverage information and the position of the user equipment.

10. The method of claim 9, wherein said selecting the one of the terrestrial initial-access procedure and the non-terrestrial initial-access procedure based on coverage information and the position of the user equipment comprises:
identifying one or more terrestrial initial-access zones and one or more non-terrestrial initial-access zones using the received coverage information;
receiving positioning reference signals from a plurality of positioning anchors;
determining a location of the user equipment based on the received positioning reference signals;
determining, from the one or more terrestrial initial-access zones and the one or more non-terrestrial initial-access zones, a zone thereof that the user equipment is located therewithin based on the determined location thereof and the coverage information; and
selecting the one of the terrestrial initial-access procedure and the non-terrestrial initial-access procedure based on the determined zone.

11. The method of claim 10, wherein the terrestrial initial-access procedure comprises:
selecting a communication node from one or more identified terrestrial communication nodes associated with the determined zone; and
establishing communication between the user equipment and the selected communication node for joining the user equipment into the communication system.

12. The method of claim 11, wherein said selecting the communication node from the one or more identified terrestrial communication nodes associated with the determined zone comprises:
scanning radio-frequency (RF) channels associated with the one or more identified terrestrial communication nodes for identifying the one or more identified terrestrial communication nodes;
selecting the communication node from the identified one or more identified terrestrial communication nodes; and
performing time and frequency synchronization between the user equipment and the selected communication node.

13. The method of claim 9, wherein the non-terrestrial initial-access procedure comprises:
selecting a communication node from one or more identified non-terrestrial communication nodes associated with the determined zone; and
establishing communication between the user equipment and the selected communication node for joining the user equipment into the communication system.

14. The method of claim 13, wherein said selecting the communication node from the one or more identified non-terrestrial communication nodes associated with the determined zone comprises:
scanning RF channels associated with the one or more identified non-terrestrial communication nodes for identifying the one or more identified non-terrestrial communication nodes;
selecting the communication node from the identified one or more identified non-terrestrial communication nodes; and
performing time and frequency synchronization between the user equipment and the selected communication node.

15. One or more non-transitory computer-readable storage devices storing computer-executable instructions for joining a user equipment into a communication system, wherein the instructions, when executed, cause a processing unit of the user equipment to perform actions comprising:
selecting one of a terrestrial initial-access procedure or a non-terrestrial initial-access procedure based on a position of the user equipment; and
executing the selected initial access procedure for joining the user equipment into the communication system.

16. The one or more non-transitory computer-readable storage devices of claim 15, wherein said selecting the one of the terrestrial initial-access procedure or the non-terrestrial initial-access procedure based on the position of the user equipment comprises:
obtaining coverage information of a service area; and
selecting the one of the terrestrial initial-access procedure and the non-terrestrial initial-access procedure based on the coverage information and the position of the user equipment.

17. The one or more non-transitory computer-readable storage devices of claim 16, wherein said selecting the one of the terrestrial initial-access procedure or the non-terrestrial initial-access procedure based on coverage information and the position of the user equipment comprises:
identifying one or more terrestrial initial-access zones and one or more non-terrestrial initial-access zones using the received coverage information;
receiving positioning reference signals from a plurality of positioning anchors;
determining a location of the user equipment based on the received positioning reference signals;
determining, from the one or more terrestrial initial-access zones and the one or more non-terrestrial initial-access zones, a zone thereof that the user equipment is located therewithin based on the determined location thereof and the coverage information; and
selecting the one of the terrestrial initial-access procedure or the non-terrestrial initial-access procedure based on the determined zone.

18. The one or more non-transitory computer-readable storage devices of claim 17, wherein the terrestrial initial-access procedure comprises:
selecting a communication node from one or more identified terrestrial communication nodes associated with the determined zone; and
establishing communication between the user equipment and the selected communication node for joining the user equipment into the communication system.

19. The one or more non-transitory computer-readable storage devices of claim 18, wherein said selecting the communication node from the one or more identified terrestrial communication nodes associated with the determined zone comprises:
scanning radio-frequency (RF) channels associated with the one or more identified terrestrial communication nodes for identifying the one or more identified terrestrial communication nodes;
selecting the communication node from the identified one or more identified terrestrial communication nodes; and
performing time and frequency synchronization between the user equipment and the selected communication node.

20. The one or more non-transitory computer-readable storage devices of claim 16, wherein the non-terrestrial initial-access procedure comprises:
selecting a communication node from one or more identified non-terrestrial communication nodes associated with the determined zone; and
establishing communication between the user equipment and the selected communication node for joining the user equipment into the communication system.
